(19) United States
(12) Patent Application Publication
(10) Pub. No.: US 2025/0281872 A1
(43) Pub. Date: Sep. 11, 2025

(54) CARBON DIOXIDE SELECTIVE MEMBRANES, GAS SEPARATION SYSTEMS INCLUDING THE CARBON DIOXIDE SELECTIVE MEMBRANES, AND RELATED METHODS

(71) Applicant: Battelle Energy Alliance, LLC, Idaho Falls, ID (US)

(72) Inventors: Birendra Adhikari, Ammon, ID (US); Christopher J. Orme, Firth, ID (US); John R. Klaehn, Idaho Falls, ID (US); Joshua S. McNally, Idaho Falls, ID (US); Frederick F. Stewart, Idaho Falls, ID (US); Hyeonseok Lee, Ammon, ID (US)

(21) Appl. No.: 18/863,585

(22) PCT Filed: May 12, 2023
(86) PCT No.: PCT/US2023/066970

§ 371 Date: Nov. 6, 2024

Related U.S. Application Data
(60) Provisional application No. 63/341,837, filed on May 13, 2022.

(51) Int. Cl. B01D 53/22; B01D 69/02; B01D 69/08; B01D 69/10; B01D 71/58; C01B 32/50

(52) U.S. Cl. CPC B01D 53/228; B01D 53/226; B01D 53/227; B01D 69/02; B01D 69/08; B01D 69/107; B01D 71/58; C01B 32/50; B01D 2256/22; B01D 2257/102; B01D 2325/02832; B01D 2325/02833

(57) ABSTRACT

A carbon dioxide (CO₂) selective membrane is disclosed and comprises a support and a selective structure comprising poly [bis(methoxy ethoxy) ethoxy)phosphazene] (MEEP) on the support. The CO₂ selective membrane exhibits a CO₂/N₂ selectivity greater than or equal to about 40/1. A gas separation system comprising one or more CO₂ selective membranes and related methods are also disclosed.

### CROSS-REFERENCE TO RELATED APPLICATIONS

This application is a national phase entry under 35 U.S.C. § 371 of International Patent Application PCT/US2023/066970, filed May 12, 2023, designating the United States of America and published as International Patent Publication WO 2023/220743 A1 on Nov. 16, 2023, which claims the benefit under Article 8 of the Patent Cooperation Treaty of U.S. Patent Application Ser. No. 63/341,837, filed May 13, 2022.

### STATEMENT REGARDING FEDERALLY SPONSORED RESEARCH OR DEVELOPMENT

This invention was made with government support under Contract Number DE-AC07-05ID14517 awarded by the United States Department of Energy. The government has certain rights in the invention.

### TECHNICAL FIELD

Embodiments of the disclosure relate to gas separation membranes, gas separation systems, and methods for capturing carbon dioxide (CO₂). More specifically, embodiments of the disclosure relate to CO₂ selective membranes for capturing carbon dioxide and related gas separation systems and methods.

### BACKGROUND

Increases in global energy demand have led to increases in the combustion of coal, natural gas, and fossil fuels, leading to a concomitant increase in carbon dioxide (CO₂) emissions. Existing industrial manufacturing infrastructure is designed to use coal, natural gas, and fossil fuels (electricity from non-renewable sources) as the primary energy source. However, concerns over adverse effects on the environment due to the presence of CO₂ in the atmosphere have driven efforts to capture and/or sequester CO₂ from the atmosphere. Carbon capture is the enrichment of CO₂ from various sources, storing the CO₂ permanently or using it for enhanced oil recovery or making fuels and chemicals such as syn gas, butanol, methanol, ethanol, and dimethyl ether. By doing this, the CO₂ is restricted from going back into the atmosphere.

Membranes have been investigated to capture CO₂ from CO₂-containing streams. Conventional membranes for CO₂ capture operate effectively at higher CO₂ concentrations, but are not effective for CO₂-containing streams containing lower concentrations of CO₂. The effectiveness of the conventional membranes drops with decreasing CO₂ concentration. In addition, manufacturing defects in the conventional membranes significantly affect the selectivity for CO₂ at lower CO₂ concentrations. Membrane-based separation processes are also expensive, due to the high costs of the membranes and of installation of systems including the membranes. In addition, electricity is used to run the membrane-based systems, adding to the overall cost. Therefore, capturing CO₂ from streams containing lower concentrations of CO₂ is expensive.

### BRIEF SUMMARY

A carbon dioxide (CO₂) selective membrane is disclosed and comprises a support and a selective structure comprising poly [bis((methoxyethoxy) ethoxy)phosphazene] (MEEP) on the support. The CO₂ selective membrane exhibits a CO₂/N₂ selectivity greater than or equal to about 40/1.

A gas separation system is also disclosed and comprises a housing and one or more CO₂ selective membranes contained within the housing. The one or more CO₂ selective membranes comprises a support and a selective structure comprising MEEP on the support, wherein the CO₂ selective membrane exhibits a CO₂/N₂ selectivity greater than or equal to about 40/1.

A method of capturing CO₂ comprises introducing a source stream containing CO₂ at a concentration of less than about 10% by weight to a first chamber of a gas separation system, transporting the CO₂ through the CO₂ selective membrane and to a second chamber of the gas separation system, and recovering the CO₂ from the second chamber of the gas separation system. The second chamber is in fluid communication with the first chamber. The gas separation system comprises one or more CO₂ selective membranes and the one or more CO₂ selective membranes comprise a support and a selective structure comprising MEEP on the support. The one or more CO₂ selective membranes exhibit a CO₂/N₂ selectivity greater than or equal to about 40/1.

### BRIEF DESCRIPTION OF THE DRAWINGS

FIG. 1 is a simplified cross-sectional view of a carbon dioxide selective membrane in accordance with embodiments of the disclosure;

FIG. 2 is a simplified schematic view of a gas separation system in accordance with embodiments of the disclosure;

FIG. 3 is a scanning electron microscopy (SEM) image of a carbon dioxide selective membrane in accordance with embodiments of the disclosure;

FIG. 4 is a graph showing CO₂ permeability as a function of temperature for carbon dioxide selective membranes in accordance with embodiments of the disclosure using pure gases;

FIG. 5 is a graph showing CO₂ selectivity as a function of temperature for carbon dioxide selective membranes in accordance with embodiments of the disclosure using pure gases;

FIG. 6 is a graph showing CO₂ permeability as a function of temperature for carbon dioxide selective membrane in accordance with embodiments of the disclosure using 1% CO₂ in N₂;

FIG. 7 is a graph showing CO₂ selectivity as a function of temperature for carbon dioxide selective membranes in accordance with embodiments of the disclosure using 1% CO₂ in N₂; and

FIG. 8 is a graph showing CO₂/N₂ selectivity as a function of CO₂ permeability for carbon dioxide selective membranes in accordance with embodiments of the disclosure.

### DETAILED DESCRIPTION

Carbon dioxide selective membranes (CO₂ selective membranes), gas separation systems, and methods for capturing and concentrating CO₂ from a source stream are disclosed. The CO₂ selective membranes, gas separation systems, and methods are used to effectively and inexpensively capture (e.g., remove) and concentrate the CO₂ from the source stream, which contains a relatively low concentration of CO₂. The CO₂ selective membrane according to embodiments of the disclosure is a multiple layer structure that exhibits CO₂ selectivity and permeability while also being durable and easy to manufacture. The CO₂ selective membrane includes a support, and a selectivity structure on the support that is formed from and includes a material highly selective to CO₂. The CO₂ selective membrane is substantially free of defects and is also self-guttering, providing the ability to repair defects. Therefore, the CO₂ selective membrane according to embodiments of the disclosure may be used to capture and enrich CO₂ from a low concentration source stream that contains CO₂.

The following description provides specific details, such as material compositions and processing conditions (e.g., temperatures, pressures, flow rates, etc.) in order to provide a thorough description of embodiments of the disclosure. However, a person of ordinary skill in the art will understand that the embodiments of the disclosure may be practiced without necessarily employing these specific details. Indeed, the embodiments of the disclosure may be practiced in conjunction with conventional systems and methods employed in the industry. In addition, only those system components and acts necessary to understand the embodiments of the disclosure are described in detail below. A person of ordinary skill in the art will understand that some system components (e.g., pipelines, line filters, valves, pumps, motors, temperature detectors, flow detectors, pressure detectors, and the like) are inherently disclosed herein and that adding various conventional system components and acts would be in accord with the disclosure. In addition, the drawings accompanying the disclosure are for illustrative purposes only, and are not meant to be actual views of any particular material, device, or system.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures. For example, if materials in the figures are inverted, elements described as “below” or “beneath” or “under” or “on bottom of”′ other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, “and/or” includes any and all combinations of one or more of the associated listed items.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, the term “compatible” means that a material does not undesirably react, decompose, or absorb another material, and also that the material does not undesirably impair the chemical and/or mechanical properties of the another material.

As used herein, the term “configured” refers to a size, shape, material composition, material distribution, and arrangement of one or more of at least one structure and at least one system facilitating operation of one or more of the structure and the system in a pre-determined way.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

A CO₂ selective membrane 100 includes a support 104 and a selectivity structure 106, as shown in FIG. 1, with the selectivity structure 106 on one or more surfaces of the selectivity structure 106. The CO₂ selective membrane 100 is configured as a gas separation membrane and is formulated to selectively remove CO₂ from a source stream that contains a low concentration of CO₂. The support 104 is configured and formulated to exhibit a high porosity and a high gas throughput (e.g., gas permeability), as well as providing mechanical strength to the CO₂ selective membrane 100. The selectivity structure 106 may be configured and formulated to be highly selective to CO₂ relative to other gaseous components of the source stream, such as nitrogen (N₂), oxygen (O₂), or a combination thereof. The CO₂ selective membrane 100 may, for example, exhibit a CO₂/N₂ selectivity greater than about 40/1 and a CO₂ permeability greater than about 450 Barrer. The CO₂ selective membrane 100 may, optionally, include one or more additives, such as a filler. If present, the additive does not substantially degrade performance (e.g., CO₂ selectivity and permeability) of the CO₂ selective membrane 100. Therefore, the CO₂ selective membrane 100 may be configured as a multiple layer structure.

The support 104 is configured and formulated to exhibit a high porosity and a high gas permeability, as well as providing mechanical strength to the CO₂ selective membrane 100. The support 104 may be a substantially rigid material that provides support and stability to the selectivity structure 106, which overlies the support 104. The support 104 is of sufficient thickness to provide the support and stability to the selectivity structure 106. By way of example only, the support 104 may be from about 0.7 mm to about 1.0 mm in thickness. The support 104 may also be substantially free of defects (e.g., pinholes) or may have a low level of defects.

Pores (not shown) may be homogeneously distributed throughout the support 104, with a size of the pores sufficient for migration (e.g., selective transport) of CO₂ therethrough while excluding other gaseous component(s) of the source stream from migrating therethrough. The pores (e.g., voids, apertures, openings, etc.) in the support 104 may be micropores that are appropriately sized to permit CO₂ to traverse through the support 104. By way of example only, the pores may be from about 0.005 μm to about 0.050 μm in diameter, such as from about 0.007 μm to about 0.040 μm, from about 0.008 μm to about 0.030 μm, from about 0.009 μm to about 0.020 μm, or from about 0.009 μm to about 0.015 μm, or from about 0.009 μm to about 0.012 μm. In some embodiments, the pores are about 0.01 μm in diameter. The pores may extend in tortuous (e.g., twisting, winding, etc.) paths throughout a thickness of the support 104 and/or may extend in substantially linear paths throughout a thickness of the support 104.

The permeance of the support 104 may be greater than or equal to about 20,000 GPU, such as from about 30,000 GPU to about 50,000 GPU or from about 35,000 GPU to about 45,000 GPU. “Permeance” is measured in GPU, where membrane thickness is unknown or inconsistent, in contrast to “permeability,” expressed in Barrers, where membrane thickness is substantially constant and known.

The support 104 may be configured as a substantially flat sheet, as shown in FIG. 1, that exhibits the desired porosity and gas permeability. Alternatively, the support 104 may be configured as hollow fibers that exhibit the desired porosity and gas permeability. With the hollow fibers, both inner surfaces and outer surfaces of the support 104 are available for the selectivity structure 106 to be formed upon. Therefore, the support 104 containing the hollow fibers may provide an increased surface area for the selectivity structure 106 to be formed upon when compared to a surface area of the substantially flat sheet. The hollow fibers may include an inner diameter and an outer diameter, where the inner diameter is less than or equal to about one-half of the outer diameter. The outer diameter of the hollow fibers may be from about 200 μm to about 400 μm, such as from about 200 μm to about 400 μm or from about 180 μm to about 200 μm.

The support 104 may be formed of and include one or more of a polymer material, a metal material, or a ceramic material that exhibits the desired porosity and gas permeability. By way of example only, the polymer material may be a polyolefin, such as a polyethylene (PE), a polypropylene, etc.; a polyamide; a polyphosphazene; a polysulfone; a fluorinated polymer, such as poly(terafluoroethylene) (PTFE), poly(vinylidene fluoride) (PVDF), etc.; a poly(ether ketone); a poly(ether ketone); a poly(ether sulfone) (PES); a polysiloxane (e.g., a polydimethylsiloxane (PDMS)); a silicone polymer; a cellulose acetate; etc., a polymeric composite material, or a combination thereof.

The support 104 may be formed of and include a metal material or a metal alloy material (e.g., cobalt, iron, nickel, aluminum, copper, magnesium, titanium, zirconium, a cobalt-based alloy, an iron-based alloy, a nickel-based alloy, an iron- and nickel-based alloy, a cobalt- and nickel-based alloy, an iron- and cobalt-based alloy, an aluminum-based alloy, a copper-based alloy, a magnesium-based alloy, a titanium-based alloy, a steel, a low-carbon steel, a stainless steel, etc.), or a combination thereof. The support 104 may, for example, be a fritted metal. In some embodiments, the support 104 is fritted stainless steel having a pore size of about 0.01 μm.

The support 104 may be formed of and include a ceramic material, such as a metal carbide material, a metal nitride material, a metal oxide material, a metal boride material, or a combination thereof. By way of example only, the support 104 may be formed of and include aluminum oxide, titanium oxide, zirconium oxide, or a mixed metal oxide. The support 104 may also be formed of and include silica, a siloxane, carbon nitride, boron nitride, a ceramic-metal composite material, a two-dimensional material (e.g., a transition metal dichalcogenide (TMDC) having a chemical formula of MX₂, where M is a transition metal and X is a chalcogen such as sulfur(S), selenium (Se), or tellurium (Te); graphene; graphene oxide; stanene; phosphorene; hexagonal boron nitride (h-BN); borophene; silicone; graphyne; germanene; germanan; a 2D supracrystal; etc.), or combinations thereof.

The substantially flat sheet of the support 104 or the hollow fibers of the support 104 may be formed by conventional techniques or may be commercially available from numerous sources. By way of example only, the hollow fibers may be formed by a phase inversion process using a specialized nozzle (e.g., a spinneret). A polymer dope is forced through the spinneret while simultaneously a flow of miscible non-solvent is pumped down the center bore of the spinneret forming the hollow fibers.

The support 104 may, optionally, include one or more additives, such as one or more fillers, to provide additional mechanical properties to the CO₂ selective membrane 100. The filler may be a nanofiller that includes, but is not limited to, nanodiamond particles, such as such as functionalized nanodiamond particles. By way of example only, the nanodiamond particles may be functionalized with carboxylic acid groups (COOH), carboxylates with alkyl groups including from one carbon atom to twenty carbon atoms (e.g., three carbon atoms (C₃), six carbon atoms (C₆), twelve carbon atoms (C₁₂), eighteen carbon atoms (C₁₈)), and perfluoro groups (e.g., —CF₂H groups, —OCH₂CF₂CF₂H groups). In some embodiments, the filler includes octadecane (C₁₈) functionalized nanodiamonds (CND). The selectivity structure 106 may include from about 1% by weight (wt %) nanodiamond particles to about 10 wt % nanodiamond particles.

The nanodiamond particles may individually exhibit a desired particle size, such as a particle size within a range of from about 2 nanometers (nm) to about 8 nm, such as within a range of from about 4 nm to about 6 nm, or from about 4 nm about 5 nm. In addition, each of the nanodiamond particles may individually exhibit a desired shape, such as at least one of a spherical shape, a hexahedral shape, an ellipsoidal shape, a cylindrical shape, a tubular shape, a conical shape, or an irregular shape. In some embodiments, each of the nanodiamond particles individually exhibits a generally spherical shape.

In some embodiments, the support 104 is formed of and includes PDMS. In other embodiments, the support 104 is formed of and includes polysulfone. In other embodiments, the support 104 is formed of and includes PVDF. In yet other embodiments, the support 104 is formed of and includes PDMS and nanodiamond particles. In yet other embodiments, the support 104 is formed of and includes polysulfone and nanodiamond particles. In still other embodiments, the support 104 is formed of and includes PVDF and nanodiamond particles.

The selectivity structure 106 of the CO₂ selective membrane 100 directly contacts the support 104. The selectivity structure 106 of the CO₂ selective membrane 100 may be configured and formulated to be highly selective to CO₂ relative to other gaseous components of the source stream, such as N₂. The selectivity structure 106 may also be highly selective for CO₂ relative to oxygen (O₂). The selectivity structure 106 may, for example, exhibit a CO₂/N₂ selectivity greater than or equal to about 40/1 at about 30° C. At a lower temperature, such as about 0° C., the CO₂/N₂ selectivity may be from about 40/1 to about 60/1 or from about 40/1 to about 70/1. The selectivity structure 106 may also be configured and formulated to repair defects in the support 104, exhibiting so-called “self-guttering” properties by filling defects, such as pinholes, in the support 104. To achieve the CO₂ selectivity and the self-guttering properties, the selectivity structure 106 may be a relatively flexible (e.g., soft, rubbery) film that is formed over the support 104.

In addition to being highly selective to CO₂, the selectivity structure 106 may be a material that is flowable at a temperature (e.g., a process temperature) at which the CO₂ selective membrane 100 is formed. The selectivity structure 106 may be formed of and include a polyphosphazene compound, which is a hybrid organic-inorganic polymer having a repeating phosphorus-nitrogen backbone and functional groups, such as organic functional groups, attached to phosphorus atoms of the polyphosphazene compound. The functional groups of the polyphosphazene compound provide mechanical properties and performance properties to the selectivity structure 106, as well as properties including thermal stability and solubility in various solvents. In some embodiments, the polyphosphazene compound is poly [bis((methoxyethoxy) ethoxy)phosphazene] (MEEP), which has a chemical structure of:

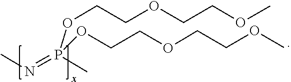

MEEP is an amorphous material having a low glass transition at −80° C. and is a soft, gel-like material at the process temperature. The polyphosphazene compound may, however, be a heteropolymer, with different functional groups on adjacent phosphorus atoms of the polyphosphazene compound.

The polyphosphazene compound functions as a selectivity material of the selectivity structure 106. Depending on the functional groups present, the polyphosphazene compound may range from being a hard, solid material to a soft gel, with the gas permeability of the polyphosphazene compound being higher with a softer material. To achieve the self-guttering properties, the functional groups of the selectivity structure 106 may be selected to formulate the selectivity structure 106 as a soft, gel-like material. The functional groups may also be selected such that the polyphosphazene compound is soluble in a coating solution and the coating solution is flowable at the process temperature.

While embodiments herein describe the polyphosphazene compound as being MEEP, other polyphosphazene compounds having different functional groups on the phosphorus atoms or a combination of polyphosphazene compounds having different functional groups on the phosphorus atoms may be used. For instance, to achieve the high CO₂ selectivity, gas permeability, and material strength (e.g., durability) properties, the polyphosphazene compound may be a heteropolymer. The polyphosphazene compound may include a crosslinking functional group, a material property functional group, and a functional group providing the polyphosphazene compound with a high affinity for CO₂ on the phosphorus atoms of the phosphorus-nitrogen backbone. The crosslinking functional group may, for example, be an allylphenol functional group, such as 2-allylphenol. The material property functional group may be a 4-methoxyphenol functional group. The functional group having affinity for CO₂ may, for example, be a (methoxyethoxy) ethoxy (MEE) functional group. However, other functional groups may be present on adjacent phosphorus atoms of the polyphosphazene compound. In the heteropolymeric polyphosphazene compound, the functional groups may be present in different ratios, depending on the desired properties of the selectivity structure 106. By way of example only, the polyphosphazene compound may include between about 70 mol % and about 100 mol % of the MEE functional group on the phosphorus-nitrogen backbone to provide the desired CO₂ selectivity. In some embodiments, about 80 mol % of the MEE functional group is present in the heteropolymeric polyphosphazene compound.

The selectivity structure 106 including the polyphosphazene compound may be configured as a layer on the substantially flat surface of the support 104 or on the sidewalls of the hollow fibers of the support 104. The selectivity structure 106 may be formed at a minimum thickness sufficient to form a substantially continuous film on the support 104. The thickness of the selectivity structure 106 may range from about 100 nm to less than or equal to about 2 μm, such as less than or equal to about 1.5 μm, less than or equal to about 1 μm, or less than or equal to about 0.5 μm. In some embodiments, the selectivity structure 106 has a thickness of about 0.5 μm.

The selectivity structure 106 may, optionally, include one or more additives, such as one or more fillers, which provide improved mechanical properties to the CO₂ selective membrane 100. The filler, when present, may increase the durability and strength of the selectivity structure 106 without decreasing its gas permeability and CO₂ selectivity. The filler, when present, may also affect rheological properties of the coating solution, such as increasing the viscosity of the coating solution. The filler may be one of the nanofillers as described above. The nanofiller may include, but is not limited to, nanodiamond particles, such as functionalized nanodiamond particles, which provide desirable dispersion characteristics in a solvent. The selectivity structure 106 may include from about 1 wt % nanodiamond particles to about 10 wt % nanodiamond particles.

In some embodiments, the filler includes octadecane (C₁₈) functionalized nanodiamonds. Unexpectedly, when the filler is present in the selectivity structure 106, the CO₂ selectivity of the CO₂ selective membrane 100 remains substantially the same (e.g., constant). In contrast, when a filler is included in a conventional gas separation membrane, the performance (e.g., CO₂ selectivity) of the conventional membrane is decreased.

The nanodiamond particles may individually exhibit a desired particle size, such as a particle size within a range of from about 2 nanometers (nm) to about 8 nm, such as within a range of from about 4 nm to about 6 nm, or from about 4 nm about 5 nm. In addition, each of the nanodiamond particles may individually exhibit a desired shape, such as at least one of a spherical shape, a hexahedral shape, an ellipsoidal shape, a cylindrical shape, a tubular shape, a conical shape, or an irregular shape. In some embodiments, each of the nanodiamond particles individually exhibits a generally spherical shape.

To form the CO₂ selective membrane 100, the coating solution of the selectivity material (e.g., MEEP) of the selectivity structure 106 may be applied to the support 104. The selectivity material may be dissolved into a solvent, such as ethanol, to form the coating solution. As used herein, the term “solution” means and includes a solution, a suspension, an emulsion, or a combination thereof. The coating solution may exhibit a viscosity that is formulated to be coatable, with the optional filler included in the coating solution to increase the viscosity as needed. The additives, if present, may be substantially soluble in the solvent of the coating solution. The coating solution may be spin coated, dip coated, sprayed, or otherwise coated onto the support 104. If the support 104 is substantially planar, the coating solution may be applied to one or more surfaces of the support 104 to form a substantially planar and substantially continuous layer of the selectivity structure 106 on the support 104. If the support 104 includes the hollow fibers, the coating solution may be applied to form the substantially continuous layer of the selectivity structure 106 on inner surfaces and outer surfaces of the hollow fibers. The coating solution may be applied to one or more of inner surfaces and outer surfaces of the hollow fibers. Since the coating solution include the selectivity material is flowable, the coating solution may flow into defects (e.g., pinholes) in the support 104 after being applied. After removing the solvent, the selectivity structure 106 is formed as a thin layer on the support 104. The solvent may be removed (e.g., volatilized) from the applied coating solution by heating to a temperature at or below the boiling point of the solvent used to form the selectivity structure 106. For instance, if ethanol is used as the solvent, the ethanol may be removed by heating to a temperature of about 70° C. The temperature used to remove the solvent may not degrade or otherwise damage the selectivity structure 106.

In some embodiments, the CO₂ selective membrane 100 includes a support 104 formed of and including PDMS and a selectivity structure 106 including MEEP. In other embodiments, the CO₂ selective membrane 100 includes a support 104 formed of and including PDMS and a selectivity structure 106 including MEEP and nanodiamond particles (e.g., CNDs).

In some embodiments, the CO₂ selective membrane 100 includes a support 104 formed of and including polysulfone and a selectivity structure 106 including MEEP. In other embodiments, the CO₂ selective membrane 100 includes a support 104 formed of and including polysulfone and a selectivity structure 106 including MEEP and nanodiamond particles (e.g., CNDs).

In some embodiments, the CO₂ selective membrane 100 includes a support 104 formed of and including PVDF and a selectivity structure 106 including MEEP. In other embodiments, the CO₂ selective membrane 100 includes a support 104 formed of and including PVDF and a selectivity structure 106 including MEEP and nanodiamond particles (e.g., CNDs).

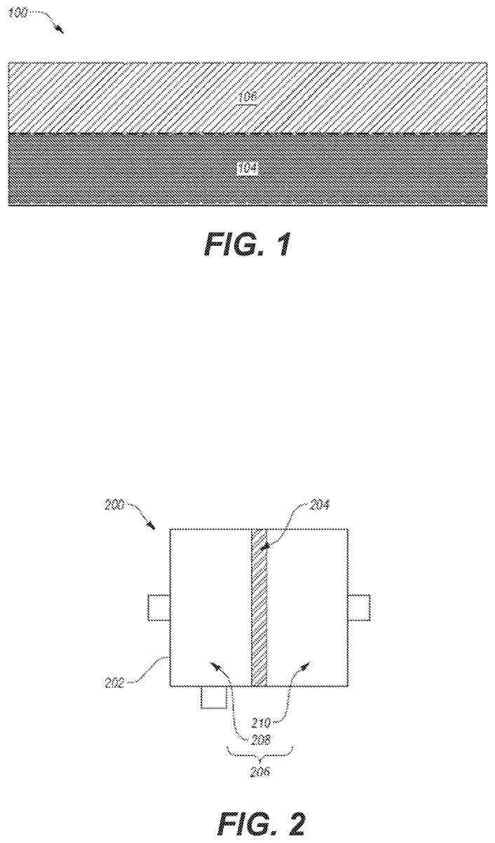

One or more of the CO₂ selective membranes 100 may be incorporated into a gas separation system 200 that is configured to capture CO₂ from the source stream, as shown in FIG. 2. The gas separation system 200 includes a housing 202 that contains the CO₂ selective membrane 204, and chambers 206 on opposing sides of the CO₂ selective membrane 204. The CO₂ selective membrane 204 is substantially similar to one or more embodiments of the CO₂ selective membrane 100 described above. Dimensions and a shape of the CO₂ selective membrane 204 may be selected depending on dimensions and a shape of the housing 202 and on the gaseous components of the source stream. The CO₂ selective membrane 204 is coupled to or integral with the housing 202. The chambers 206 may include a first chamber 208 on one side of the CO₂ selective membrane 204 and a second chamber 210 on another, opposing, side of the CO₂ selective membrane 204, with the CO₂ selective membrane 204, the first chamber 208, and the second chamber 210 in fluid communication with the source stream. For simplicity, some components (e.g., pipelines, line filters, valves, pumps, motors, temperature detectors, flow detectors, pressure detectors, etc.) of the gas separation system 200 are not included in FIG. 2.

The housing 202 of the gas separation system 200 may exhibit any shape (e.g., a tubular shape, a quadrilateral shape, a spherical shape, a semi-spherical shape, a cylindrical shape, a semi-cylindrical shape, truncated versions thereof, or an irregular shape) and size able to contain (e.g., hold) the CO₂ selective membrane 204 therein, and to direct the source stream to a first side of the CO₂ selective membrane 204 and to direct a product stream (e.g., a concentrated CO₂ stream) to a second side of the CO₂ selective membranes 204. The housing 202 may be formed of and include any material (e.g., glass, metal, alloy, polymer, ceramic, composite, combinations thereof, etc.) compatible with the source stream and with the operating conditions (e.g., temperatures, pressures, material interactions) of the gas separation system 200.

The housing 202 may at least partially define the chambers 206 of the gas separation system 200, with the CO₂ selective membrane 204 between the first chamber 208 and the second chamber 210. The CO₂ selective membrane 204 may serve as a boundary between the chambers 206, with the first chamber 208 configured and positioned to receive the source stream and to direct the source stream to the CO₂ selective membrane 204, and the second chamber 210 configured and positioned to receive the product stream and to direct the product stream from the gas separation system 200. The source stream is introduced to the first chamber 208 through an inlet (not shown), passes through the CO₂ selective membrane 204, and the product stream (e.g., the concentrated carbon dioxide stream) exits the second chamber 210 through an outlet (not shown).

While FIG. 2 illustrates one (e.g., a single) CO₂ selective membrane 204, the gas separation system 200 may include multiple CO₂ selective membranes 204. The multiple CO₂ selective membranes 204 may be provided in parallel with one another or in series with one another within the housing 202.

During use and operation of the gas separation system 200, CO₂ is removed (e.g., captured) and concentrated from the source stream. The source stream may be contained in a storage vessel (not shown) and subsequently introduced to the first chamber 208 of the gas separation system 200 through the inlet. The source stream is a gaseous source stream that contains less than about 10% wt % of CO₂, such as between about 0.1 wt % and about 10% wt of CO₂. The source stream may be ambient air or atmospheric air, which includes about 80% by volume of N₂, about 21% by volume of 02, and about 0.4% by volume of CO₂. Alternatively, the source stream may be an industrial offgas (e.g., an industrial exhaust gas, an industrial flue gas), such as an offgas or a flue gas from the steel, cement, or oil and gas industry. The source stream may be introduced to the first chamber at a flow rate of from about 20 ml min-1 to about 150 ml min⁻¹. However, other flow rates may be used depending on the gas permeability of the CO₂ selective membrane 204 and the surface area of the CO₂ selective membrane 204. Higher flow rates may be used if, for example, the gas separation system 200 is used to remove and concentrate CO₂ from industrial quantities of the source stream.

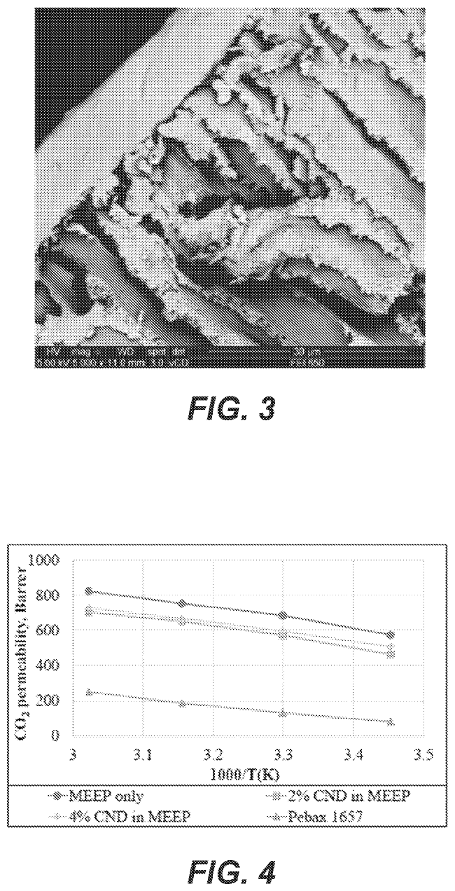

The CO₂ in the source stream is transported through the CO₂ selective membrane 204 by a transmembrane pressure gradient and into the second chamber 210, while other gaseous components of the source stream remain in the first chamber 208. When the CO₂ selective membrane 100 is configured as hollow fibers having the layer of the selectivity structure 106 thereon, as shown in FIG. 3, an increased surface area of the selectivity structure 106 is exposed to the source stream, increasing the CO₂/N₂ selectivity. Therefore, the CO₂ is selectively separated from the other gaseous components of the source stream. The CO₂ is selectively separated from the other gaseous components of the source stream without using a solvent during use and operation of the gas separation system 200.

The gas separation system 200 may be operated at a temperature of less than about 70° C., such as less than about 60° C., less than about 50° C., less than about 40° C., or less than about 30° C. In some embodiments, the gas separation system 200 is operated at about 30° C.

The product stream in the second chamber 210 includes CO₂ at a higher concentration than was present in the source stream. The product stream is recovered from the second chamber 210 through the outlet. The product stream may contain between about 15 wt % and about 50 wt % of CO₂, such as between about 20 wt % and about 50 wt % of CO₂, between about 25 wt % and about 50 wt % of CO₂, between about 30 wt % and about 50 wt % of CO₂, between about 35 wt % and about 50 wt % of CO₂, between about 40 wt % and about 50 wt % of CO₂, between about 45 wt % and about 50 wt % of CO₂, between about 20 wt % and about 40 wt % of CO₂, between about 20 wt % and about 35 wt % of CO₂, between about 25 wt % and about 30 wt % of CO₂, or between about 20 wt % and about 25 wt % of CO₂. In some embodiments, the product stream includes greater than about 20 wt % of CO₂. The gas separation system 200 may be used to recover the CO₂ in a product stream containing greater than about 20 wt % CO₂ after conducting a single pass of the source stream through the CO₂ selective membrane 204 of the gas separation system 200. The product stream may also be of a high purity, such as having a CO₂ purity of greater than about 90 wt %, such as greater than about 95 wt % or greater than about 99 wt %.

The product stream including the concentrated CO₂ may be collected for use as a starting material or as a commodity chemical. The product stream may, for example, be used in various industries, such as in oil recovery, chemical production/manufacturing, or coal-fired power plants. Alternatively, the product stream including the concentrated CO₂ may be sequestered. Since the product stream may be produced at a low cost, the recovered CO₂ may be used in various industrial processes that are currently too expensive to conduct using CO₂ recovered using conventional gas separation membranes.

The gaseous components of the source stream that remain in the first chamber 208 may be recovered and disposed of or utilized. The gaseous components may form a CO₂ depleted stream that is used as a starting material or as a commodity chemical in other industrial processes.

The self-guttering properties of the selectivity structure 106 substantially reduce or eliminate the defects present in the support 104 and enable the CO₂ selective membrane 100, according to embodiments of the disclosure, to be used to capture and recover CO₂ from the air or other low concentration CO₂-containing source streams. Therefore, the CO₂ may be captured and recovered from the low concentration CO₂-containing source stream by a cost-effective process. Although the process of forming the CO₂ selective membrane 100 according to embodiments of the disclosure includes forming an additional layer, which adds to production time, the high CO₂ selectivity of the CO₂ selective membrane 100 outweighs the increased production time.

The following examples serve to explain embodiments of the disclosure in more detail. These examples are not to be construed as being exhaustive, exclusive, or otherwise limiting as to the scope of the disclosure.

### EXAMPLES

### Example 1

MEEP was prepared by reacting a sodium salt of 2-(2-methoxyethoxy) ethanol with poly [bis-(chloro)phosphazene]. The MEEP was sprayed on a PDMS support to observe the CO₂ selectivity of the resulting CO₂ selective membrane. The PDMS support was commercially available. The source stream included 1 wt % of CO₂ and 99 wt % of N₂ and was passed through the PDMS/MEEP CO₂ selective membrane. Passing the source stream through the PDMS/MEEP CO₂ selective membrane increased the concentration of CO₂ from 390 ppm to 2000 ppm. In comparison, passing the source stream through a PDMS only membrane increased the CO₂ concentration from 390 ppm to 800 ppm.

### Example 2

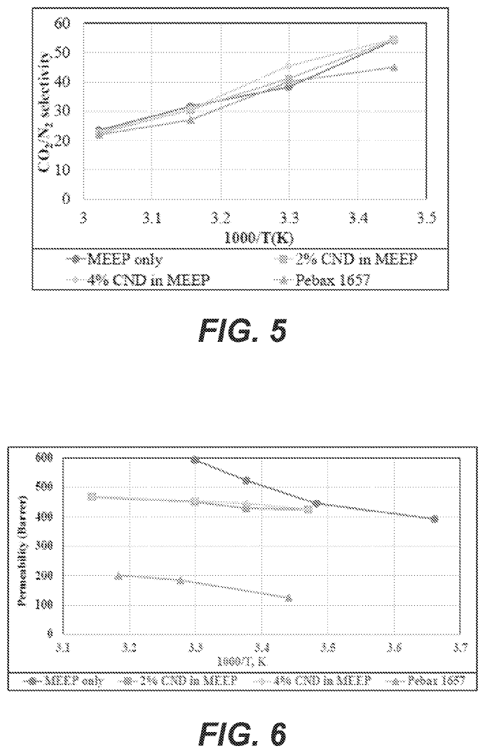

A solution including MEEP was sprayed on a polysulfone support. Solutions including MEEP and octadecane (C₁₈) functionalized nanodiamonds (CND) were also sprayed on a polysulfone support. The solutions included 2% C₁₈ functionalized CNDs and 4% C₁₈ functionalized CNDs. The CO₂ permeability of the resulting CO₂ selective membranes was measured, as shown in FIG. 4. The CO₂/N₂ selectivity of the resulting CO₂ selective membranes was measured, as shown in FIG. 5. A PEBAX® membrane, PEBAX® 1657, was used as a control. Pure gas permeation (CO₂, N₂, O₂) was measured through the CO₂ selective membranes.

The MEEP-based CO₂ selective membranes showed a significantly higher CO₂ permeability than the PEBAX® 1657 at a given temperature. The MEEP-based CO₂ selective membranes showed a generally higher CO₂/N₂ selectivity than the PEBAX® 1657 at a given temperature.

### Example 3

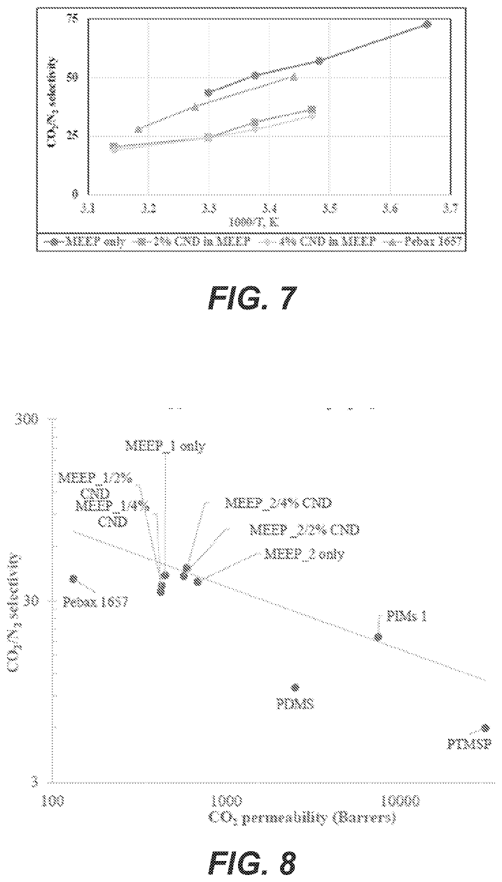

The CO₂ permeability of the CO₂ selective membranes described in Example 2 was measured, as shown in FIG. 6. The CO₂/N₂ selectivity of the CO₂ selective membranes described in Example 2 was measured, as shown in FIG. 7. A PEBAX® membrane, PEBAX® 1657, was used as a control. Permeation of a gas containing 1% CO₂ in N₂ was measured through the CO₂ selective membranes.

The MEEP-based CO₂ selective membranes showed a significantly higher CO₂ permeability than the PEBAX® 1657 at a given temperature. The MEEP-based CO₂ selective membrane showed a higher CO₂/N₂ selectivity than the PEBAX® 1657 at a given temperature. The MEEP-based CO₂ selective membranes including the C₁₈ functionalized CNDs showed a lower CO₂/N₂ selectivity than the PEBAX® 1657 at a given temperature.

### Example 4

A comparison of the CO₂ permeability and the CO₂/N₂ selectivity of the MEEP-based CO₂ selective membranes with and without C₁₈ functionalized CNDs was determined. A PEBAX® membrane, PEBAX® 1657, and PDMS were used as a control. As shown in FIG. 8, the MEEP-based CO₂ selective membranes without C₁₈ functionalized CNDs exhibited high selectivities and exceptional permeabilities. The MEEP-based CO₂ selective membranes with C₁₈ functionalized CNDs exhibited reasonable selectivities and exceptionally high permeabilities. The MEEP-based CO₂ selective membranes with the C₁₈ functionalized CNDs also exhibited increased mechanical properties (data not shown).

### Example 5

MEEP- and PEBAX®-based membranes were evaluated using the United States Department of Energy (US DOE) developed Greenhouse gases, Regulated Emissions and Energy in Transportation (GREET) fuel-cycle model and database. The model calculates fuel cycle emissions of 6 pollutants: carbon monoxide, nitrogen oxides, sulfur oxides, volatile organic compounds, and particulate matter with a diameter of 10 microns or less, and three greenhouse gases: CO₂, methane, and nitrous oxide. The basis of CO₂ separation was 1% CO₂ in nitrogen for the MEEP membranes, while the basis of separation parameters for other membranes, such as the PEBAX® derived membranes, is as reported in the literature. The PEBAX® membranes were formed from block copolymers including polyamide block and polyether blocks. Most membranes have used pure gas measurements, and some have used a 50/50 CO₂/N₂ mixture. Some of the PEBAXR-based membranes included nanofilled-filled membranes, such as PEBAX® ZIF-8. A comparison of the permeability and CO₂/N₂ selectivity for the MEEP- and PEBAX®-based membranes is shown in Table 1.

TABLE 1
Comparison of Physical Properties of MEEP- and PEBAX ®-based Membranes

| | | | Separation | | |
|---|---|---|---|---|---|
| | | Feed gas | condition | | |
| | Membrane | (CO₂ | (Temperature | | |
| | thickness | vol %/N₂ | ° C./Pressure | Permeability | CO₂/N₂ |
| Membrane | (μm) | vol %) | bar) | (Barrer) | selectivity |
| MEEP | 0.1 | 99/1 | 15/1 | 100.0 | 40.0 |
| MEEP/CND | 0.1 | 99/1 | 15/1 | 100.0 | 35.0 |
| Pristine PEBAX ® (lower end) | 1 | pure gas | 25/1 | 55.0 | 40.0 |
| Pristine PEBAX ® (higher end) | 1 | pure gas | 25/1 | 100.0 | 70.0 |
| PEBAX ®/ZIF-8 | 105 | pure gas | 23/1 | 105.0 | 34.8 |
| PEBAX ®/ZIF-8(90 nm) | 55 | pure gas | 25/1 | 154.0 | 40.5 |
| PEBAX ®/ZIF-8-90(50) | 75 | pure gas | 35/— | 217.5 | 54.1 |
| PEBAX ®/NH2-ZIF-8 | — | pure gas | 25/1 | 163.8 | 62.0 |
| PEBAX ®/UiO-66 | 18 | 50/50 | 25/3 | 97.2 | 56.6 |
| PEBAX ®/NH2-MIL-53 | 75 | pure gas | 35/10 | 120.0 | 55.5 |
| PEBAX ®/MoS2 nanosheet | 28 | pure gas | 30/1 | 52.3 | 90.6 |
| PEBAX ®/NaY | 23 | pure gas | 30/2 | 82.8 | 35.0 |
| PEBAX ®/NOTT300 | 38 | pure gas | 25/10 | 395.2 | 61.2 |
| PEBAX ®/MCM-41 | 88 | pure gas | 25/2 | 122.5 | 53.0 |
| PEBAX ®/GO | 83 | 20/80 | 35/2 | 105.0 | 41.2 |
| PEBAX ®/aminosilane-GO | 83 | 20/80 | 35/2 | 166.3 | 45.2 |
| PEBAX ®/PEI-ZIF-8 | 1 | 50/50 | 25/1 | 13.0 | 49.0 |

Properties of the PEBAX®-based membranes were as reported from the literature.

Embodiment 1: A carbon dioxide (CO₂) selective membrane, comprising: a support and a selective structure comprising poly [bis((methoxyethoxy) ethoxy)phosphazene] (MEEP) on the support. The CO₂ selective membrane exhibits a CO₂/N₂ selectivity greater than or equal to about 40/1.

Embodiment 2: The CO₂ selective membrane of Embodiment 1, wherein the support comprises a polymer, a metal, or a ceramic.

Embodiment 3: The CO₂ selective membrane of Embodiment 1 or Embodiment 2, wherein the support comprises a substantially flat sheet of a polymer, a metal, or a ceramic.

Embodiment 4: The CO₂ selective membrane of Embodiment 1 or Embodiment 2, wherein the support comprises hollow fibers of a polymer.

Embodiment 5: The CO₂ selective membrane of any of Embodiments 1-4, wherein the support exhibits a thickness of from about 0.7 mm to about 1.0 mm.

Embodiment 6: The CO₂ selective membrane of any of Embodiments 1-5, wherein pores are homogeneously distributed throughout the support.

Embodiment 7: The CO₂ selective membrane of Embodiment 6, wherein the pores exhibit a diameter of from about 0.008 μm to about 0.030 μm.

Embodiment 8: The CO₂ selective membrane of any of Embodiments 1-7, wherein the selective structure directly contacts one or more surfaces of the support.

Embodiment 9: The CO₂ selective membrane of any of Embodiments 1-8, further comprising one or more nanofillers.

Embodiment 10: The CO₂ selective membrane of Embodiment 9, wherein the one or more nanofillers comprise nanodiamond particles.

Embodiment 11: The CO₂ selective membrane of Embodiment 9 or Embodiment 10, wherein the one or more nanofillers comprise octadecane functionalized nanodiamonds.

Embodiment 12: The CO₂ selective membrane of any of Embodiments 1-11, wherein the MEEP further comprises between about 70 mol % and about 100 mol % of a (methoxyethoxy) ethoxy functional group on a phosphorus-nitrogen backbone of the MEEP.

Embodiment 13: A gas separation system, the gas separation system comprising: a housing and one or more carbon dioxide (CO₂) selective membranes contained within the housing. The one or more CO₂ selective membranes comprise a support and a selective structure comprising poly [bis((methoxyethoxy) ethoxy)phosphazene] (MEEP) on the support, wherein the one or more CO₂ selective membranes exhibits a CO₂/N₂ selectivity greater than or equal to about 40/1.

Embodiment 14: The gas separation system of Embodiment 13, wherein the gas separation system comprises two or more CO₂ selective membranes and the two or more CO₂ selective membranes are configured in series.

Embodiment 15: The gas separation system of Embodiment 13, wherein the gas separation system comprises two or more CO₂ selective membranes and the two or more CO₂ selective membranes are configured in parallel.

Embodiment 16: A method of capturing carbon dioxide (CO₂) comprising introducing a source stream containing CO₂ at a concentration of less than about 10% by weight to a first chamber of a gas separation system, transporting the CO₂ through the one or more CO₂ selective membranes and to a second chamber of the gas separation system, the second chamber in fluid communication with the first chamber, and recovering the CO₂ from the second chamber of the gas separation system. The gas separation system comprises one or more CO₂ selective membranes and the one or more CO₂ selective membranes comprise a support and a selective structure comprising poly [bis((methoxyethoxy) ethoxy)phosphazene] (MEEP) on the support, wherein the selective structure exhibits a CO₂/N₂ selectivity greater than or equal to about 40/1.

Embodiment 17: The method of Embodiment 16, wherein introducing a source stream containing CO₂ at a concentration of less than about 10% by weight to a first chamber of a gas separation system comprises introducing the source stream containing CO₂ at a concentration of between about 1% by weight and about 10% by weight to the first chamber.

Embodiment 18: The method of Embodiment 16 or Embodiment 17, wherein introducing a source stream containing CO₂ at a concentration of less than about 10% by weight to a first chamber of a gas separation system comprises introducing air or an industrial offgas to the first chamber of the gas separation system.

Embodiment 19: The method of any of Embodiments 16-18, wherein recovering the CO₂ comprises recovering a product stream comprising the CO₂ at greater than or equal to about 15% by weight.

Embodiment 20: The method of any of Embodiments 16-19, wherein transporting the CO₂ through the one or more CO₂ selective membranes comprises transporting the CO₂ without transporting nitrogen gas (N₂) through the one or more CO₂ selective membranes.

While the disclosure is susceptible to various modifications and alternative forms, specific embodiments have been shown by way of example in the drawings and have been described in detail herein. However, the disclosure is not limited to the particular forms disclosed. Rather, the disclosure is to cover all modifications, equivalents, and alternatives falling within the scope of the following appended claims and their legal equivalent. For example, elements and features disclosed in relation to one embodiment may be combined with elements and features disclosed in relation to other embodiments of the disclosure.

1. A carbon dioxide (CO₂) selective membrane, comprising:
a support; and
a selective structure comprising poly [bis((methoxyethoxy) ethoxy)phosphazene] (MEEP) on the support,
wherein the CO₂ selective membrane exhibits a CO₂/N₂ selectivity greater than or equal to about 40/1.

2. The CO₂ selective membrane of claim 1, wherein the support comprises a polymer, a metal, or a ceramic.

3. The CO₂ selective membrane of claim 1, wherein the support comprises a substantially flat sheet of a polymer, a metal, or a ceramic.

4. The CO₂ selective membrane of claim 1, wherein the support comprises hollow fibers of a polymer.

5. The CO₂ selective membrane of claim 1, wherein the support exhibits a thickness of from about 0.7 mm to about 1.0 mm.

6. The CO₂ selective membrane of claim 1, wherein pores are homogeneously distributed throughout the support.

7. The CO₂ selective membrane of claim 6, wherein the pores exhibit a diameter of from about 0.008 μm to about 0.030 μm.

8. The CO₂ selective membrane of claim 1, wherein the selective structure directly contacts one or more surfaces of the support.

9. The CO₂ selective membrane of claim 1, further comprising one or more nanofillers.

10. The CO₂ selective membrane of claim 9, wherein the one or more nanofillers comprise nanodiamond particles.

11. The CO₂ selective membrane of claim 9, wherein the one or more nanofillers comprise octadecane functionalized nanodiamonds.

12. The CO₂ selective membrane of claim 1, wherein the MEEP further comprises between about 70 mol % and about 100 mol % of a (methoxyethoxy) ethoxy functional group on a phosphorus-nitrogen backbone of the MEEP.

13. A gas separation system, the gas separation system comprising:
a housing; and
one or more carbon dioxide (CO₂) selective membranes contained within the housing, the one or more CO₂ selective membranes comprising:
a support; and
a selective structure comprising poly [bis((methoxyethoxy) ethoxy)phosphazene] (MEEP) on the support, wherein the one or more CO₂ selective membranes exhibits a CO₂/N₂ selectivity greater than or equal to about 40/1.

14. The gas separation system of claim 13, wherein the gas separation system comprises two or more CO₂ selective membranes and the two or more CO₂ selective membranes are configured in series.

15. The gas separation system of claim 13, wherein the gas separation system comprises two or more CO₂ selective membranes and the two or more CO₂ selective membranes are configured in parallel.

16. A method of capturing carbon dioxide (CO₂) comprising:
introducing a source stream containing CO₂ at a concentration of less than about 10% by weight to a first chamber of a gas separation system, the gas separation system comprising one or more CO₂ selective membranes and the one or more CO₂ selective membranes comprising:
a support; and
a selective structure comprising poly [bis((methoxyethoxy) ethoxy)phosphazene] (MEEP) on the support, wherein the selective structure exhibits a CO₂/N₂ selectivity greater than or equal to about 40/1;
transporting the CO₂ through the one or more CO₂ selective membranes and to a second chamber of the gas separation system, the second chamber in fluid communication with the first chamber; and
recovering the CO₂ from the second chamber of the gas separation system.

17. The method of claim 16, wherein introducing a source stream containing CO₂ at a concentration of less than about 10% by weight to a first chamber of a gas separation system comprises introducing the source stream containing CO₂ at a concentration of between about 1% by weight and about 10% by weight to the first chamber.

18. The method of claim 16, wherein introducing a source stream containing CO₂ at a concentration of less than about 10% by weight to a first chamber of a gas separation system comprises introducing air or an industrial offgas to the first chamber of the gas separation system.

19. The method of claim 16, wherein recovering the CO₂ comprises recovering a product stream comprising the CO₂ at greater than or equal to about 15% by weight.

20. The method of claim 16, wherein transporting the CO₂ through the one or more CO₂ selective membranes comprises transporting the CO₂ without transporting nitrogen gas (N₂) through the one or more CO₂ selective membranes.
